(19) United States
(12) Patent Application Publication
(10) Pub. No.: US 2010/0136332 A1
(43) Pub. Date: Jun. 3, 2010

(54) RUBBER-REINFORCING CARBON FIBER CORD AND METHOD FOR PRODUCING THE SAME

(75) Inventors: Naomitsu Murayama, Ibaraki-shi (JP); Masatsugu Furukawa, Ibaraki-shi (JP)

Correspondence Address: SUGHRUE MION, PLLC, 2100 PENNSYLVANIA AVENUE, N.W., SUITE 800, WASHINGTON, DC, 20037, US

(73) Assignee: TOHO TENAX Co., Ltd., Chiyoda-ku, Tokyo (JP)

(21) Appl. No.: 12/532,587

(22) PCT Filed: Mar. 18, 2008
(86) PCT No.: PCT/JP2008/054969

§ 371 Date: Sep. 22, 2009

(30) Foreign Application Priority Data
Mar. 23, 2007 (JP) 2007-076495

(51) Int. Cl. B32B 27/02; D02G 1/02

(52) U.S. Cl. 428/367; 57/362

(57) ABSTRACT

To provide a rubber-reinforcing cord having good adhesion to rubber and exhibiting excellent fatigue resistance to stress deformation such as bending deformation, and a method for producing the same.

Disclosed a rubber-reinforcing carbon fiber cord in which a resin composition containing a styrenic thermoplastic elastomer resin modified with maleic acid or the like adheres to a carbon fiber bundle that the number of filaments is from 500 to 50,000. The styrenic thermoplastic elastomer resin is preferably a styrene-terminated ethylene-butylene copolymer resin, and the resin composition preferably contains at least one sticky resin of a hydrogenated terpene resin, a β-pinene resin and a terpene resin.

### TECHNICAL FIELD

The present invention relates to a rubber-reinforcing carbon fiber cord and a method for producing the same, and more particularly to a rubber-reinforcing carbon fiber cord which can be suitably used in industrial materials such as tires, belts and hoses and a method for producing the same.

### BACKGROUND ART

Traditionally, fiber-reinforced rubber materials reinforced with rubber-reinforcing cords have been used in industrial materials such as tires, belts and hoses. In these rubber materials, organic fibers such as nylon fiber and polyester fiber have hitherto been generally used as reinforcing cords. The fiber-reinforced rubber materials reinforced with such rubber-reinforcing cords have been widely used because of their practical fatigue resistance.

This rubber-reinforcing cord requires characteristics such as tensile strength, tensile modulus of elasticity, heat resistance, water resistance and fatigue resistance. Above all, the rubber material is largely deformed by an external force or the like, so that in order to give durability, importance is attached to bending fatigue resistance of fibers constituting the reinforcing cord.

Carbon fiber has good tensile strength, tensile modulus of elasticity, heat resistance and water resistance, so that a fiber-reinforced rubber material using carbon fiber is excellent in dimensional stability, weather resistance and the like. However, there has been a problem that breakage of a cord due to abrasion of monofilaments with each other and interfacial debonding between the cord and rubber are liable to occur, resulting in poor fatigue resistance.

As attempts for solving such a problem, there have hitherto been proposed a rubber-reinforcing cord in which a carbon fiber buddle is impregnated with a resin composition containing a blocked isocyanate derivative (patent document 1) and a rubber-reinforcing cord in which a carbon fiber buddle is impregnated with a resin composition containing polyurethane (patent document 2).

However, even the above-mentioned rubber-reinforcing cords can not be said to be sufficient in fatigue resistance yet, when used in applications such as tires, belts and hoses, and fatigue resistance is insufficient. Under the present situation, of the rubber-reinforcing cords using carbon fiber, one having substantially problem-free fatigue resistance has never been obtained.

Patent Document 1: JP-A-2001-200067

Patent Document 2: JP-A-2002-71057

### DISCLOSURE OF THE INVENTION

### Problems that the Invention is to Solve

An object of the present invention is to provide a rubber-reinforcing carbon fiber cord having good adhesion to rubber and exhibiting excellent fatigue resistance to stress deformation such as bending deformation and a method for producing the same.

### Means for Solving the Problems

The present invention relates to a rubber-reinforcing carbon fiber cord characterized in that a resin composition containing an acid-modified styrenic thermoplastic elastomer resin adheres to a carbon fiber bundle.

Next, the present invention relates to a method for producing a rubber-reinforcing carbon fiber cord, characterized in that a carbon fiber bundle is treated with a resin composition containing an acid-modified styrenic thermoplastic elastomer resin.

In the above-mentioned method for producing a rubber-reinforcing carbon fiber cord, the cord may be subjected to (I) single twist or (II) double twist in the following manner:

(I) Single Twist:

A method for producing a rubber-reinforcing carbon fiber cord comprising treating a substantially twistless carbon fiber bundle with a resin composition containing an acid-modified styrenic thermoplastic elastomer resin to prepare a twistless yarn, and imparting a single twist to the one yarn or a plurality of the yarns combined, in the range shown by the following equation (1):

1.5≦TC≦3.5 Equation (1)

wherein TC=twist coefficient=(1/3,031)×T (D)^{1/2}

T: the number of twists imparted (T/m)

D: the linear density (dtex) of one or a plurality of carbon fiber bundles

(II) Double Twist:

A method for producing a rubber-reinforcing carbon fiber cord comprising treating a substantially twistless carbon fiber bundle with a resin composition containing an acid-modified styrenic thermoplastic elastomer resin to prepare a twistless yarn, imparting a preliminarily twist to the one yarn or a plurality of the yarns combined, and further imparting a final twist thereto in the range shown by the following equation (2):

2.0≦TC(final twist coefficient)≦7 Equation (2)

wherein TC=twist coefficient=(1/3,031)×T(D)^{1/2}

T: the number of twists imparted (T/m)

D: the linear density (dtex) of one or a plurality of carbon fiber bundles

Incidentally, in this double twist (II), the above-mentioned preliminary twist is preferably a twist in the range shown by the following equation (3):

1≦TC≦5 Equation (3)

wherein TC=twist coefficient=(1/3,031)×T(D)^{1/2}

T: the number of twists imparted (twists/m) (T/m)

D: the linear density (dtex) of one or a plurality of carbon fiber bundles

The above acid-modified styrenic thermoplastic elastomer resin is preferably a maleic acid-modified styrenic thermoplastic elastomer resin.

Further, the styrenic thermoplastic elastomer resin is preferably a styrene-terminated ethylene-butylene copolymer resin.

Still further, the styrenic thermoplastic elastomer resin is preferably constituted from styrene, ethylene and butylene, and the molar ratio of styrene/(ethylene+butylene) in the elastomer resin is from 5/95 to 50/50.

Furthermore, the above-mentioned resin composition may contain a sticky resin, in addition to the acid-modified styrenic thermoplastic elastomer resin.

The sticky resins as used herein include one containing at least one of a hydrogenated terpene resin, a β-pinene resin and a terpene resin as a component thereof.

Further, the amount of the above-mentioned resin composition adhered is preferably from 1 to 50 parts by weight based on 100 parts by weight of the carbon fiber bundle.

Still further, the above-mentioned resin composition preferably has a breaking strength of 0.5 MPa or more and a breaking elongation of 750% or more.

Furthermore, it is preferred that the rubber-reinforcing carbon fiber cord of the present invention is treated with a resorcin-formalin-rubber latex-based adhesive composition, whereby a resorcin-formalin-rubber latex-based resin adhesive adheres to an uppermost surface thereof.

The number of filaments of the above carbon fiber bundle used in the present invention is preferably from 500 to 50,000.

Then, the present invention relates a fiber-reinforced rubber material characterized in that it is reinforced with the above rubber-reinforcing carbon fiber cord.

### ADVANTAGES OF THE INVENTION

According to the present invention, there are provided a rubber-reinforcing carbon fiber cord having good adhesion to rubber and exhibiting excellent fatigue resistance to stress deformation such as bending deformation and a method for producing the same.

### BRIEF DESCRIPTION OF THE DRAWINGS

FIG. 1 is a schematic view showing a device for measuring fatigue resistance.

### DESCRIPTION OF REFERENCE NUMERALS AND SIGNS

1: Twisted Cord
2: Load
3: Roller
4: Other End Oscillated

### BEST MODE FOR CARRYING OUT THE INVENTION

The rubber-reinforcing carbon fiber cord of the present invention is one in which a resin composition containing an acid-modified styrenic thermoplastic elastomer resin adheres to a carbon fiber bundle. Further, the acid-modified styrenic thermoplastic elastomer resin is preferably a maleic acid-modified styrenic thermoplastic elastomer resin.

There is no particular limitation on the carbon fiber bundle used in the present invention, as long as filaments are collected together into a bundle-like yarn. The number of filaments constituting the bundle is preferably from 500 to 50,000, and more preferably from 3,000 to 12,000. When the number of filaments is too small, force applied to one filament is concentrated. Conversely, when it is too large, the distribution of force in the fiber bundle becomes uneven. Accordingly, fatigue resistance tend to decrease. The diameter of one filament constituting the fiber bundle is preferably within the range of 1 to 20 μm, particularly 5 to 10 μm.

Incidentally, the carbon fiber bundle used is substantially twistless. That is to say, the number of twists thereof is satisfactorily 30 twists/m or less, preferably 20 twists/m or less, and more preferably 10 twists/m or less. When the number of twists exceeds 30 twists/m, a portion unimpregnated with the resin composition occurs in a central portion of the cord. As a result, abrasion of monofilaments with each other occurs to sometimes impair durability of the fiber-reinforced rubber material.

Further, the larger the amount of oxygen on a surface of the carbon fiber in the carbon fiber bundle is, the better it is, because wettability of the carbon fiber by the resin composition containing the acid-modified styrenic thermoplastic elastomer resin is improved, and consequently, adhesion of the carbon fiber to rubber and fatigue resistance are also improved. When the surface oxygen concentration measured by X-ray photoelectron spectroscopy (XPS: ESCA) is taken as O/C, the amount of oxygen is preferably O/C≧0.05, and more preferably O/C≧0.1. Here, in order to obtain a surface oxygen concentration of 0.05 or more, it is possible to obtain it by performing known gas-phase or liquid-phase surface treatment.

Furthermore, in order to sufficiently impregnating the carbon fiber bundle with the resin composition, the linear density of the carbon fiber bundle is preferably not so high. The linear density of the carbon fiber bundle is preferably 12,000 dtex or less, more preferably 6,000 dtex or less and particularly preferably from 1,000 to 3,000 dtex.

The rubber-reinforcing carbon fiber cord of the present invention is a cord comprising such a carbon fiber bundle, the tensile modulus (modulus of elasticity) thereof is preferably 100 GPa or more, more preferably 230 GPa or more, and particularly preferably 280 GPa or more. The upper limit of the tensile modulus is 1,000 GPa or less, and further 700 GPa or less, in a usual range. The fiber-reinforced rubber material reinforced with the carbon fiber bundle becomes excellent in dimensional stability by increasing the tensile modulus of the carbon fiber bundle. Further, the tensile strength of the carbon fiber bundle is preferably from 2,000 to 10,000 MPa, and more preferably within the range of 3,000 to 6,000 MPa. Furthermore, in order to improve fatigue resistance, the elongation at break is also important, and it is preferably from 0.2 to 3.0%, and more preferably from 1.5 to 2.5%.

In the rubber-reinforcing carbon fiber cord of the present invention, it is essential that the resin composition containing the acid-modified styrenic thermoplastic elastomer resin adheres to the carbon fiber bundle as described above. As acid modified resin of the styrenic thermoplastic elastomer resin, preferred is an acid-modified styrenic thermoplastic elastomer resin obtained by graftizing an unsaturated acid compound. Preferred examples of the unsaturated acid compounds include maleic acid anhydride, maleic acid, itaconic acid anhydride, itaconic acid, fumaric acid, methacrylic acid, acrylic acid and the like. Above all, the maleic acid-modified styrenic thermoplastic elastomer resin is preferred, and it becomes possible to more improve adhesion to rubber because it has carboxyl groups.

Here, the styrenic thermoplastic elastomer resins specifically include a styrene-isoprene-styrene copolymer, a styrene-butadiene-styrene copolymer, a styrene-ethylene-butylene-styrene copolymer, a styrene-ethylene-ethylene-propylene-styrene copolymer, a styrene-ethylene-propylene-styrene copolymer elastomer and the like. Above all, preferred is a styrene-terminated ethylene-butylene copolymer resin such as a styrene-ethylene-butylene-styrene copolymer.

In particular, it is preferred that the styrenic thermoplastic elastomer resin is constituted from styrene, ethylene and butylene, and that the molar ratio of styrene/(ethylene+butylene) in the elastomer resin is from 5/95 to 50/50. Further, the molar ratio is more preferably from 10/90 to 30/70. When the ratio of styrene decreases, the ratio of soft segments increases. As a result, the tensile elastic modulus of the resin decrease, so that the improvement rate of fatigue resistance tends to decrease. Conversely, when the ratio of styrene increases too much, the ratio of soft segments decreases. As a result, the resin becomes too hard, so that the improvement rate of fatigue resistance also tends to decrease.

In general, the styrenic thermoplastic elastomer resin has a flexible structure in spite of its tensile strength, so that it is rich in elasticity like rubber. Accordingly, fatigue resistance of the fiber to bending deformation in the case where a rubber-fiber composite is constituted becomes extremely good by adhering the resin composition containing the acid-modified styrenic thermoplastic elastomer resin as described above to the carbon fiber bundle. The acid-modified styrenic thermoplastic elastomer resin used in the present invention has toughness and is a resin having good adhesion to rubber, so that scum does not adhere to roller portions in a process in large amounts like a usual adhesive composition, which makes it possible to improve physical properties of the carbon fiber cord.

Further, it is more preferred that the resin composition which adheres to the rubber-reinforcing carbon fiber cord of the present invention contains a sticky resin, in addition to the above-mentioned acid-modified styrenic thermoplastic elastomer resin, as long as it is within the range not generating scum in large amounts. The use of the resin having stickiness can further improve adhesion between the carbon fiber and rubber. As specific examples of such sticky resins, particularly preferred is any one of a hydrogenated terpene resin, an aromatic modified hydrogenated terpene resin, a terpene resin, an aromatic modified terpene resin, a terpene phenol resin, an aromatic modified terpene phenol resin, an α-pinene resin and a β-pinene resin, or a resin copolymerized with another resin, based on these resins. Above all, when any one or more of a hydrogenated terpene resin, a β-pinene resin and a terpene resin is contained, compatibility with a rubber-fiber adhesive such as an RFL adhesive is particularly good, which makes it possible to more improve adhesion between the carbon fiber cord and rubber.

The amount of the sticky resin incorporated in the above-mentioned resin composition is usually from 20 to 80% by weight, and preferably from about 40 to 60% by weight, in the resin composition.

As the amount of the resin composition adhered in the present invention, it is preferred that the acid-modified styrenic thermoplastic resin is adhered to the above-mentioned carbon fiber bundle in an amount of 1 to 50 parts by weight based on 100 parts by weight of the carbon fiber bundle. It is further preferred to be adhered in an amount of 5 to 30 parts by weight, and optimally in an amount of 10 to 20 parts by weight. When the amount of the acid-modified styrenic thermoplastic elastomer resin-containing resin composition adhered is too small, the effect of preventing abrasion of monofilaments with each other tends to become insufficient. Conversely, when the amount of the resin composition adhered is too large, the diameter of the fiber cord increases, whereby stress caused by bending deformation in a rubber-fiber structure increases, resulting in the tendency of easy destruction of the structure.

In the present invention, the resin composition as described above is adhered to the carbon fiber bundle, thereby extremely improving fatigue resistance to bending deformation. Incidentally, in the present invention, it is preferred that the resin composition adheres over the substantially whole circumferential surface of the cord to coat the cord.

Further, it is preferred that the resin composition used in the present invention has a breaking strength of 0.5 MPa or more and a breaking elongation of 750% or more. Furthermore, the breaking strength of a film coating comprising the resin composition is preferably within the range of 0.5 to 50 MPa, particularly within the range of 1 to 10 MPa. In addition, the elongation is preferably from 750 to 5,000%, and particularly within the range of 1,500 to 3,000%. When the breaking strength of the resin composition is too low, the resin coating adhered to the surface of the carbon fiber tends to be broken by compression of the carbon fiber filaments with each other during a process or the like, so that the improvement rate of fatigue resistance tends to decrease. This tendency is particularly significant, when the carbon fiber bundle is twisted. Further, when the breaking strength is too low, the resin coating adhered to the surface of the carbon fiber tends to be insufficient in flexibility, and bending fatigue resistance tend not to be improved so much.

In order to adjust the breaking strength to 0.5 MPa or more and the breaking elongation to 750% or more, a combination of the above-mentioned styrenic thermoplastic elastomer resin and sticky resin may be changed. For example, the breaking elongation can be increased by increasing the ratio of the sticky resin.

Further, it is preferred that a resorcin-formalin-rubber latex-based resin adhesive (hereinafter referred to as an “RFL adhesive”) adheres to an uppermost surface of the rubber-reinforcing carbon fiber cord of the present invention. By further adhering the RFL adhesive to the carbon fiber bundle to which the resin composition containing the styrenic thermoplastic elastomer resin, which is essential in the present invention, is adhered, there is also an effect that the affinity of the RFL adhesive with the resin composition used in the present invention is extremely high. Thus, adhesion force between rubber and the fiber is further improved. Then, interfacial debonding between rubber and the carbon fiber becomes difficult to occur by improvement of adhesion force, and an effect of improving fatigue resistance is also exhibited.

The above-mentioned FRL adhesive is prepared by a method of adding resorcin and formalin into an aqueous alkali solution containing an alkaline compound, for example, such as sodium hydroxide, followed by standing at room temperature for several hours to carry out an initial condensation of resorcin and formalin, and thereafter, adding a rubber latex to form a mixed emulsion.

Here, as the rubber latex, there can be used an acrylonitrile-butadiene latex, an isoprene rubber latex, a urethane rubber latex, a styrene-butadiene rubber latex, a vinylpyridine-styrene-butadiene rubber latex or the like. Above all, a vinylpyridine-styrene-butadiene rubber latex is particularly effective for improvement of fatigue resistance, and preferably used.

Incidentally, the above-mentioned RFL adhesive is a so-called water-based adhesive containing water before drying, so that it is preferred to dry and remove water by heating after adhered to the surface of the cord, from the viewpoint of preventing the occurrence of voids which cause insufficient durability of the rubber-reinforcing carbon fiber cord.

The amount of the RFL adhesive adhered is preferably from 1 to 10% by weight, and more preferably from 2 to 8% by weight, based on 100% by weight of the carbon fiber bundle. When it is too small, an effect of improving rubber adhesion can not be expected. On the other hand, when it is too large, the cord tends to become hard, resulting in having an opposite effect on fatigue resistance. In the present invention, in order to further improve adhesion with rubber, it is also preferred to previously adhere an epoxy compound-containing compound (hereinafter also referred to as “epoxy treatment”) before the RFL adhesive is adhered.

Here, the epoxy compound-containing compounds used in the epoxy treatment include epoxy compounds, isocyanate compounds containing epoxy compounds, or reaction products thereof.

Specific examples of the epoxy compounds as used herein include glycerol polyglycidyl ether, sorbitol polyglycidyl ether, trimethylolpropane polyglycidyl ether, neopentyl glycol polyglycidyl ether, polyethylene glycol polyglycidyl ether, polypropylene glycol polyglycidyl ether and the like. Above all, glycerol polyglycidyl ether and sorbitol polyglycidyl ether are particularly effective for improvement of adhesion.

Further, as specific examples of the isocyanate compounds, there can be exemplified metaphenylene diisocyanate, diphenylmethane diisocyanate, a reaction product of the isocyanate with phenol, cresol, ε-caprolactam or acetoxime, and the like.

For the ratio of the epoxy compound and the isocyanate compound, it is preferred that the molar ratio of epoxy groups and isocyanate groups (including blocked isocyanate groups) is within the range of epoxy groups/isocyanate groups=0.1/1 to 2/1. The ratios outside this range cause deterioration of fatigue resistance or a decrease in adhesion in some cases. There is no problem at all even when the epoxy compound and the isocyanate compound form reactants.

In the present invention, the amount of the epoxy compound-containing compound in the epoxy treatment is satisfactorily from 0.1 to 10% by weight, preferably form 0.5 to 8% by weight, and more preferably from 2 to 4% by weight, based on 100% by weight of the carbon fiber bundle. Less than 0.1% by weight results in easy occurrence of interfacial debonding between rubber and the carbon fiber bundles to cause insufficient fatigue resistance of the fiber-reinforced rubber material in some cases. On the other hand, exceeding 10% by weight leads to increased hardness of the carbon fiber cord to cause a decrease in fatigue resistance of the carbon fiber cord in some cases.

Such a rubber-reinforcing carbon fiber cord of the present invention becomes a fiber cord which has good adhesion with rubber and excellent fatigue resistance to bending deformation, and particularly in which breakage of the cord due to abrasion of monofilaments with each other is difficult to occur, while having a high tensile modulus of elasticity and a high tensile strength.

The method for producing a carbon fiber cord, which is the other present invention, is characterized in that a carbon fiber bundle is treated with a resin composition containing an acid-modified styrenic thermoplastic elastomer resin. Similarly to the above, the styrenic thermoplastic elastomer resin is preferably a maleic acid-modified styrenic thermoplastic elastomer resin, and a basic skeleton of the styrenic thermoplastic elastomer resin is preferably a styrene-terminated ethylene-butylene copolymer resin. Further, the resin composition is preferably one containing a sticky resin, in addition to the acid-modified styrenic thermoplastic elastomer resin, and particularly, it is preferred that the sticky resin contains at least one of a hydrogenated terpene resin, a β-pinene resin and a terpene resin as a component thereof.

Further, in the treatment of the present invention, a treatment liquid containing the acid-modified styrenic thermoplastic elastomer resin is generally used in an aqueous dispersion. Although there is no particular limitation on a method for preparing the aqueous dispersion of the resin composition containing the acid-modified styrenic thermo-plastic elastomer resin, examples thereof include (a) a method of producing it by forcedly dispersing the maleic acid-modified styrenic thermoplastic elastomer resin in an aqueous dispersion medium in which a surfactant, a dispersing agent and the like are dissolved, under heating by a means such as stirring, (b) a method of producing it by such a post-emulsion method that the maleic acid-modified styrenic thermoplastic elastomer resin dissolved in a water-insoluble organic solvent is stirred and emulsified in an aqueous dispersion medium together with a surfactant by high shear force, followed by removal of the organic solvent, and the like.

In these cases, the solid concentration of the above-mentioned resin composition in the aqueous dispersion is usually from 10 to 60% by weight, and preferably from about 20 to 40% by weight.

In the present invention, it is preferred that the carbon fiber bundle is substantially twistless before the treatment with such a resin composition. The resin composition uniformly adheres around the carbon fiber bundle because it is twistless, thereby improving fatigue resistance. Further, it is also preferred to impart a twist to a yarn comprising the carbon fiber bundle or a plurality of the yarns combined, after the carbon fiber bundle has been treated with the resin composition. Force applied to the respective monofilaments constituting the yarn in the rubber structure is distributed by imparting the twist, so that fatigue resistance are improved.

As the more specific method for producing rubber-reinforcing carbon fiber cord of the present invention, for example, the carbon fiber bundle is immersed in the treatment liquid containing the acid-modified styrenic thermoplastic elastomer resin, and thereafter, allowed to pass through a heated-air drying furnace to dry it, thereby being able to produce the carbon fiber cord. Further, the carbon fiber cord can also be produced by immersing in the treatment liquid containing the acid-modified styrenic thermoplastic elastomer resin and drying during a sizing process of the carbon fiber.

In this case, as drying and heat treatment conditions, the temperature is from 110 to 270° C., and preferably from 150 to 220° C., and the treating time is from 0.5 to 10 minutes, and preferably from 1 to 3 minutes.

Further, when the carbon fiber bundle is subjected to the epoxy treatment before RFL treatment described later, adhesion between rubber and the carbon fiber cord is improved. This is therefore preferred.

As drying and heat treatment conditions in the epoxy treatment, the temperature is from 110 to 270° C., and preferably from 130 to 230° C., and the treating time is from 0.5 to 10 minutes, and preferably from 1 to 3 minutes.

Furthermore, it is also preferred for improving adhesion that the uppermost surface of the carbon fiber cord is treated with the resorcin-formalin-rubber latex-based adhesive composition (hereinafter also referred to as “RFL treatment”). When the RFL adhesive is adhered, it is preferred that the resin-adhered carbon fiber bundle obtained by the above-mentioned means is twisted, and then, immersed in the treatment liquid containing the RFL adhesive, followed by drying, thereby adhering the adhesive to the twisted cord.

As drying and heat treatment conditions in the RFL treatment, the temperature is from 110 to 270° C., and preferably from 130 to 230° C., and the treating time is from 0.1 to 10 minutes, and preferably from 1 to 3 minutes.

Incidentally, in the production method of the present invention, the cord in which the carbon fiber bundle is treated with the resin composition containing the acid-modified styrenic thermoplastic elastomer resin may be subjected to (I) single twist or (II) double twist.

Here, in the case of the single twist (I), the carbon fiber bundle is treated with the resin composition containing the acid-modified styrenic thermoplastic elastomer resin in a state of a substantially twistless yarn to prepare a twistless yarn, and a single twist is imparted to the one yarn or a plurality of the yarns combined, in the range shown by the following equation (1), thereby imparting the single twist to the cord.

1.5≦TC≦3.5 Equation (1)

wherein TC=twist coefficient=(1/3,031)×T(D)^{1/2}

T: the number of twists imparted (T/m)

D: the linear density (dtex) of one or a plurality of carbon fiber bundles

Force applied to the respective monofilaments constituting the yarn in the rubber structure is distributed by imparting the twist, so that fatigue resistance are improved. However, when the twist coefficient of equation (1) is smaller than 1.5, fatigue resistance of the carbon fiber cord is insufficient, and can not be substantially used as a rubber-reinforcing cord. Conversely, when the twist coefficient of equation (1) is larger than 3.5, the tensile modulus of elasticity becomes a low value, so that a characteristic of using the carbon fiber is lost. Further, a decrease in tensile strength is also observed. Also from such viewpoints, the more preferred range of the twist coefficient in equation (1) is from 2 to 3.

Furthermore, in the case of the double twist (II), the substantially twistless carbon fiber bundle is treated with the resin composition containing the acid-modified styrenic thermoplastic elastomer resin to prepare a twistless yarn, a preliminary twist is imparted to the one yarn or a plurality of the yarns combined, and further a final twist is imparted in the range shown by the following equation (2), thereby imparting the double twist to the cord.

2.0≦TC(final twist coefficient)≦7 equation (2)

wherein TC=twist coefficient=(1/3,031)×T(D)^{1/2}

T: the number of twists imparted (T/m)

D: the linear density (dtex) of one or a plurality of carbon fiber bundles

Incidentally, in the double twist (II), the above-mentioned preliminary twist is preferably a twist in the range shown by the following equation (3):

1≦TC≦5 Equation (3)

wherein TC=twist coefficient=(1/3,031)×T(D)^{1/2}

T: the number of twists imparted (twists/m) (T/m)

D: the linear density (dtex) of one or a plurality of carbon fiber bundles

Force applied to the respective monofilaments constituting the yarn in the rubber structure is distributed by imparting the twist, so that fatigue resistance are improved. However, when the twist coefficient of the final twist of equation (2) is smaller than 2.0, fatigue resistance of the carbon fiber cord is insufficient, and can not be substantially used as a rubber-reinforcing cord. Conversely, when the twist coefficient of equation (2) is larger than 7, the tensile modulus of elasticity becomes a low value, so that a characteristic of using the carbon fiber is lost. Further, a decrease in tensile strength is also observed. Also from such viewpoints, the more preferred range of the twist coefficient in equation (2) is from 4 to 6.

The same also applies to the twist coefficient of the preliminary twist. When the twist coefficient of the preliminary twist of equation (3) is smaller than 1, fatigue resistance of the carbon fiber cord is insufficient, and can not be substantially used as a rubber-reinforcing cord. Conversely, when the twist coefficient of equation (3) is larger than 5, the tensile modulus of elasticity becomes a low value, so that a characteristic of using the carbon fiber is lost. Further, a decrease in tensile strength is also observed. Also from such viewpoints, the more preferred range of the twist coefficient in equation (3) is from 2.5 to 4.

The fiber-reinforced rubber material of the present invention is a fiber-reinforced rubber material reinforced with such a rubber-reinforcing carbon fiber cord of the present invention. The resulting fiber-reinforced rubber material exhibits excellent durability to bending deformation and the like. Specific examples of such fiber-reinforced rubber materials include tires, belts, hoses and the like.

Rubbers used in the fiber-reinforced rubber material of the present invention include acrylic rubber, acrylonitrile-butadiene rubber, isoprene rubber, urethane rubber, ethylene-propylene rubber, chloroprene rubber, silicone rubber, styrene-butadiene rubber, polysulfide rubber, natural rubber, butadiene rubber, fluororubber and the like.

Incidentally, in addition to the rubber as a main component, the above-mentioned rubber may contain an inorganic filler such as carbon black or silica, organic filler such as a coumarone resin or a phenol resin, or a softening agent such as naphthenic oil, for modification of the material.

Such a fiber-reinforced rubber material can be formed, for example, by arranging the required number of the above-mentioned rubber-reinforcing cords, and putting them in the rubber, followed by further pressing and heating with a press machine. The resulting fiber-reinforced rubber material exhibits excellent durability to bending deformation and the like, and can be suitably used for tires, belts, hoses and the like.

### EXAMPLES

The present invention will be specifically illustrated below with reference to Examples. Respective physical properties shown in Examples were measured by the following methods:

(1) Tensile Strength and Tensile Modulus of Elasticity of Carbon Fiber Bundle

Tensile Strength and tensile Modulus of Elasticity of a twistless carbon fiber bundle was measured in accordance with JIS R7601.

(2) Fatigue Resistance (Bending Cycles Until Breakage)

Bending Fatigue Resistance

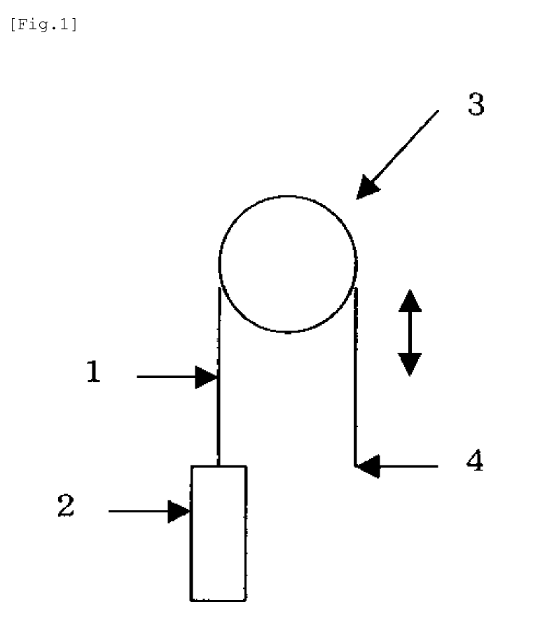

As shown in FIG. 1, a load of 1.0 kg was attached to one end of a twisted cord subjected to adhesive treatment, and the cord was hung around a roller of diameter 10 mm. The other end was oscillated in the long axis fibrous direction of the cord at amplitude of 50 mm and a rate of 100 cycles/min, thereby repeatedly bending the cord. The cycles until breakage were measured. 50,000 cycles or more until bending breakage was evaluated as AA, 30,000 cycles to less than 50,000 cycles as A, 15,000 cycles to less than 30,000 cycles as B, and less than 15,000 cycles as C.

(3) Adhesion (Pull-Out Adhesion Force)

Measurement was made in accordance with JIS L1017. As a rubber for evaluation, there was used a rubber of natural rubber/styrene-butadiene rubber (weight ratio)=6/4. The case where the adhesion force in pulling out one cord from the rubber exceeded 130 N was evaluated as A, the case of 65 to 130 N as B, and the case of less than 65 N as C.

(4) Tensile Characteristic of Carbon Fiber Cord

The tensile characteristic of carbon fiber cord after twist processing was measured in accordance with JIS L1017. Here, the crosshead speed was 250 mm/min, and the initial sample length was 500 mm. Incidentally, the tensile modulus of elasticity was determined from a point at which the slope of a tangent line became steepest in an S-S curve (a strength-elongation graph).

(5) Tensile Strength and Elongation of Film Coating

Measurement was made in accordance with JIS K6301. A treatment liquid was dried at room temperature for 24 hours, at 80° C. for 10 hours, and at 120° C. for 30 minutes to prepare a coating having a thickness of 0.8 to 0.9 mm. From this coating, a sample was cut out, and the tensile strength and elongation of the film coating was determined by using a tensile testing machine.

(6) Surface Oxygen Concentration O/C of Carbon Fiber Bundle

The surface oxygen concentration O/C of carbon fiber was determined by XPS (ESCA) according to the following procedure. That is to say, the carbon fiber was cut, and spread and disposed on a sample supporting table made of stainless steel. Then, the photoelectron escape angle was set to 90 degrees, MgKa was used as an X-ray source, and the degree of vacuum in a sample chamber was kept to 1×10⁻⁶ Pa. As correction of a peak associated with charge at the time of measurement, first, the binding energy value B.E. of a main peak of Cls was adjusted to 284.6 eV. The Ols peak area was determined by drawing a linear base line in the range of 528 to 540 eV, and the Cls peak area was determined by drawing a linear base line in the range of 282 to 292 eV. Then, the surface oxygen concentration O/C on a surface of the carbon fiber was determined by calculating the ratio of the above-mentioned Ols peak area and Cls peak area.

Further, in Examples, materials shown below were used in producing cords and fiber-reinforced rubber materials.

(a) Carbon Fiber Bundle

Carbon Fiber Bundle (1)

Linear density: 2,000 dtex, “HTA-3K” (manufactured by Toho Tenax Co., Ltd.), number of filaments: 3,000, monofilament diameter: 7.0 μm, tensile strength: 3,920 MPa, tensile modulus of elasticity: 235 GPa, elongation: 1.7%, surface oxygen concentration: O/C=0.18

Carbon Fiber Bundle (2)

Linear density: 4,000 dtex, “HTA-6K” (manufactured by Toho Tenax Co., Ltd.), number of filaments: 6,000, monofilament diameter: 7.0 μm, tensile strength: 3,920 MPa, tensile modulus of elasticity: 235 GPa, elongation: 1.7%, surface oxygen concentration: O/C=0.18

(b) Treating Agent

Styrenic Treating Agent (1);

An aqueous dispersion of a maleic acid-modified styrene-ethylene-butylene-styrene copolymer resin, breaking strength of a film coating: 3.8 MPa, breaking elongation: 760%, solid concentration=30% by weight

Styrenic Treating Agent (2);

An aqueous dispersion of a maleic acid-modified styrene-ethylene-butylene-styrene copolymer resin:a hydrogenated terpene resin (weight ratio)=5:5, breaking strength of a film coating: 3.6 MPa, breaking elongation: 2950%, solid concentration=30% by weight

Styrenic Treating Agent (3);

An aqueous dispersion of a maleic acid-modified styrene-ethylene-butylene-styrene copolymer resin:a β-pinene resin (weight ratio)=5:5, breaking strength of a film coating: 1.4 MPa, breaking elongation: 1640%, solid concentration=30% by weight

Styrenic Treating Agent (4);

An aqueous dispersion of a maleic acid-modified styrene-ethylene-butylene-styrene copolymer resin:a terpene resin (weight ratio)=5:5, breaking strength of a film coating: 4.8 MPa, breaking elongation: 2030%, solid concentration=30% by weight

Incidentally, in the above-mentioned styrenic treating agents (1) to (4), the S/EB (styrene/(ethylene+butylene) ratio (molar ratio)) of the maleic acid-modified styrene-ethylene-butylene-styrene copolymer resin was 20/80.

(c) Polyurethane

Urethane-based treating agent: polyester-based polyurethane aqueous dispersion “Super Flex” E-2000 (manufactured by Daiichi Kogyo Seiyaku Co., Ltd.), solid concentration=50% by weight

(d) RFL Adhesive

As an RFL adhesive, the following Sumikanol 700S, 2518FS and Nipol LX-112 were mixed at a weight ratio of 7:65:28 and diluted with water to use

“Sumikanol 700S”: manufactured by Sumitomo Chemical Co., Ltd., a resorcinol-formalin condensate

“Nipol 2518FS”: manufactured by Zeon Corporation, a vinylpyridine-styrene-butadiene rubber latex

“Nipol LX-112”: manufactured by Zeon Corporation, a styrene-butadiene rubber latex

### Example 1

Carbon fiber bundle (1) was conveyed at a rate of 10 m/min, immersed, in a twistless state, in an aqueous dispersion (concentration: 10% by weight) in which styrenic treating agent (1) was diluted with pure water, and allowed to pass through a heating furnace having a temperature of 190° C., taking 60 seconds, to remove water. The weight of the carbon fiber per constant length was previously measured, and the weight of the cord with the same length after immersed in the treatment liquid was measured. From the difference therebetween, the amount of the acid-modified styrenic thermoplastic elastomer resin-containing resin composition adhered was measured. The resulting carbon fiber bundle was preliminarily twisted at 25 (T/10 cm) on a ring twister, and the two bundles preliminarily twisted were combined together and finally twisted under conditions of 25 (T/10 cm). Then, the resulting cord was immersed in an aqueous dispersion (concentration=4% by weight) containing an epoxy compound (sorbitol polyglycidyl ether, manufactured by Nagase ChemteX Corporation, EX-611) and a blocked isocyanate (a methyl ethyl ketoxime block material of diphenylmethane diisocyanate, manufactured by Meisei Chemical Works, Ltd., DM-6400) at a weight ratio of 1:3, and allowed to pass through a heating furnace of 130° C., taking 2 minutes, to remove water. Then, the cord is heat treated in a heating furnace of 230° C., taking 1 minute, to adhere them in a dry amount of 3% by weight. Subsequently, the cord was immersed in an RFL adhesive treatment liquid (the ratio of an RFL adhesive was 20% by weight), allowed to pass through a heating furnace of 150° C., taking 2 minutes, to remove water, and then, heat treated in a heating furnace of 200° C., taking 1 minute, to prepare a rubber-reinforcing carbon fiber cord. The amount of the RFL adhesive adhered was 3.5% by weight based on 100% by weight of the carbon fiber bundle. The results thereof are shown in Table 1.

### Example 2

A rubber-reinforcing cord was prepared in the same manner as in Example 1 with the exception that styrenic treating agent (1) was changed to styrenic treating agent (2) containing the hydrogenated terpene resin. The results thereof are shown together in Table 1.

### Example 3

A rubber-reinforcing cord was prepared in the same manner as in Example 1 with the exception that styrenic treating agent (1) was changed to styrenic treating agent (3) containing the β-pinene resin. The results thereof are shown together in Table 1.

### Example 4

A rubber-reinforcing cord was prepared in the same manner as in Example 1 with the exception that styrenic treating agent (1) was changed to styrenic treating agent (4) containing the terpene resin. The results thereof are shown together in Table 1.

### Example 5

A rubber-reinforcing cord was prepared in the same manner as in Example 2 with the exception that the aqueous dispersion concentration diluted with pure water in styrenic treating agent (2) was changed to 25% by weight. The results thereof are shown together in Table 1.

### Comparative Example 1

A rubber-reinforcing cord was prepared in the same manner as in Example 1 with the exception that no styrenic treating agent (1) was used. The results thereof are shown together in Table 1.

### Comparative Example 2

A rubber-reinforcing cord was prepared in the same manner as in Example 1 with the exception that styrenic treating agent (1) was changed to a urethane-based treating agent (diluted with water to a concentration of 10% by weight). This had a problem that monofilaments were put together by adhesion of the agent at the time of yarn treatment, thereby being broken in twisting to cause fluffing, and was one having poor adhesion.

TABLE 1

| | | | | | Bending |
|---|---|---|---|---|---|
| | | Dry Amount | | | Fatigue |
| | Treating Agent | Adhered | RFL Treatment | Adhesion | resistance |
| Example 1 | Styrenic treating | 15% | Treated | B | AA |
| | agent (1) | | | | |
| Example 2 | Styrenic treating | 15% | Treated | A | AA |
| | agent (2) | | | | |
| Example 3 | Styrenic treating | 15% | Treated | A | AA |
| | agent (3) | | | | |
| Example 4 | Styrenic treating | 30% | Treated | B | AA |
| | agent (4) | | | | |
| Example 5 | Styrenic treating | 40% | Treated | B | AA |
| | agent (2) | | | | |
| Comparative | Not used | 0% | Treated | A | C |
| Example 1 | | | | | |

### Example 6

Carbon fiber bundle (2) was conveyed at a rate of 10 m/min, immersed, in a twistless state, in an aqueous dispersion (concentration: 10% by weight) in which styrenic treating agent (3) was diluted with pure water, and allowed to pass through a heating furnace having a temperature of 190° C., taking 100 seconds, to remove water. The weight of the carbon fiber per constant length was previously measured, and the weight of the cord with the same length after immersed in the treatment liquid was measured. From the difference therebetween, the amount of the acid-modified styrenic thermoplastic elastomer resin-containing resin composition adhered was measured. The resulting carbon fiber bundle was twisted at 10 (T/10 cm) (twist coefficient: 2.09) on a ring twister. Then, the resulting cord was immersed in an aqueous dispersion (concentration=10% by weight) containing an epoxy compound (sorbitol polyglycidyl ether, manufactured by Nagase ChemteX Corporation, EX-611) and a rubber latex (a vinylpyridine-styrene-butadiene rubber latex, manufactured by Zeon Corporation, Nipol 2518FS) at a weight ratio of 1:25, and allowed to pass through a heating furnace of 130° C., taking 2 minutes, to remove water. Then, the cord is heat treated in a heating furnace of 230° C., taking 1 minute, to adhere them in a dry amount of 3% by weight. Subsequently, the cord was immersed in an RFL adhesive treatment liquid (the ratio of an RFL adhesive was 20% by weight), allowed to pass through a heating furnace of 150° C., taking 2 minutes, to remove water, and then, heat treated in a heating furnace of 200° C., taking 1 minute, to prepare a rubber-reinforcing carbon fiber cord. The amount of the RFL adhesive adhered was 3.5% by weight based on 100% by weight of the carbon fiber bundle. The results thereof are shown in Table 2.

### Example 7

A rubber-reinforcing cord was prepared in the same manner as in Example 6 with the exception that the number of twists was changed to 14 (T/10 cm) (twist coefficient: 2.92). The results thereof are shown together in Table 2.

TABLE 2

| | | Number of | | Tensile | | Bending |
|---|---|---|---|---|---|---|
| | linear density | Twists | Twist | Modulus | | Fatigue |
| | (dtex) | (T/m) | Coefficient | of Elasticity | Adhesion | resistance |
| Example 6 | 4,000 | 100 | 2.09 | 171 | A | AA |
| Example 7 | 4,000 | 140 | 2.92 | 132 | A | AA |

### Example 8

Carbon fiber bundle (1) was conveyed at a rate of 10 m/min, immersed, in a twistless state, in an aqueous dispersion (concentration: 10% by weight) in which styrenic treating agent (3) was diluted with pure water, and allowed to pass through a heating furnace having a temperature of 190° C. to remove water. The weight of the carbon fiber per constant length was previously measured, and the weight of the cord with the same length after immersed in the treatment liquid was measured. From the difference therebetween, the amount of the acid-modified styrenic thermoplastic elastomer resin-containing resin composition adhered was measured. The resulting carbon fiber bundle was preliminarily twisted at 25 (T/10 cm) (twist coefficient: 3.70) on a ring twister, and the two bundles preliminarily twisted were combined together and finally twisted under conditions of 25 (T/10 cm) (twist coefficient: 5.22). Then, the resulting cord was immersed in an aqueous dispersion (concentration=10% by weight) containing an epoxy compound (sorbitol polyglycidyl ether, manufactured by Nagase ChemteX Corporation, EX-611) and a rubber latex (a vinylpyridine-styrene-butadiene rubber latex, manufactured by Zeon Corporation, Nipol 2518FS) at a weight ratio of 1:25, and allowed to pass through a heating furnace of 130° C., taking 2 minutes, to remove water. Then, the cord is heat treated in a heating furnace of 230° C., taking 1 minute, to adhere them in a dry amount of 3% by weight. Subsequently, the cord was immersed in an RFL adhesive treatment liquid (the ratio of an RFL adhesive was 20% by weight), allowed to pass through a heating furnace of 150° C., taking 2 minutes, to remove water, and then, heat treated in a heating furnace of 200° C., taking 1 minute, to prepare a rubber-reinforcing carbon fiber cord. The amount of the RFL adhesive adhered was 3.5% by weight based on 100% by weight of the carbon fiber bundle. The results thereof are shown in Table 3.

### Example 9

A rubber-reinforcing cord was prepared in the same manner as in Example 8 with the exceptions that the number of preliminary twists was changed to 20 (T/10 cm) (twist coefficient: 3.0) and that the number of final twists was changed to 20 (T/10 cm) (twist coefficient: 4.2). The results thereof are shown in Table 3.

### Example 10

A rubber-reinforcing cord was prepared in the same manner as in Example 8 with the exceptions that the number of preliminary twists was changed to 33 (T/10 cm) (twist coefficient: 4.9) and that the number of final twists was changed to 33 (T/10 cm) (twist coefficient: 6.9). The results thereof are shown in Table 3.

### Example 11

A rubber-reinforcing cord was prepared in the same manner as in Example 8 with the exceptions that the number of preliminary twists was changed to 10 (T/10 cm) (twist coefficient: 1.5) and that the number of final twists was changed to 10 (T/10 cm) (twist coefficient: 2.1). The results thereof are shown in Table 3.

TABLE 3

| | | Number of | Number of | | | | |
|---|---|---|---|---|---|---|---|
| | | Preliminary | Final | | | Tensile | Bending |
| | Twist | Twists/Twist | Twists/Twist | Treating | | Modulus of | Fatigue |
| | Constitution | Coefficient | Coefficient | Agent | RFL Treatment | Elasticity | resistance |
| Example 8 | 2000 dtex/ | 250 T/m/3.7 | 250 T/m/5.22 | Styrenic | Treated | 157 | AA |
| | 1 × 2 | | | (3) | | | |
| Example 9 | 2000 dtex/ | 200 T/m/3.0 | 200 T/m/4.17 | Styrenic | Treated | 163 | A |
| | 1 × 2 | | | (3) | | | |
| Example 10 | 2000 dtex/ | 330 T/m/4.9 | 330 T/m/6.89 | Styrenic | Treated | 139 | A |
| | 1 × 2 | | | (3) | | | |
| Example 11 | 2000 dtex/ | 100 T/m/1.48 | 100 T/m/2.09 | Styrenic | Treated | 170 | B |
| | 1 × 2 | | | (3) | | | |

### INDUSTRIAL APPLICABILITY

The fiber-reinforced rubber material reinforced with the rubber-reinforcing carbon fiber cord of the present invention is useful for industrial materials such as tires, belts and hoses.

1. A rubber-reinforcing carbon fiber cord characterized in that a resin composition containing an acid-modified styrenic thermoplastic elastomer resin adheres to a carbon fiber bundle.

2. The rubber-reinforcing carbon fiber cord according to claim 1, wherein the acid-modified styrenic thermoplastic elastomer resin is a maleic acid-modified styrenic thermoplastic elastomer resin.

3. The rubber-reinforcing carbon fiber cord according to claim 1, wherein the styrenic thermoplastic elastomer resin is a styrene-terminated ethylene-butylene copolymer resin.

4. The rubber-reinforcing carbon fiber cord according to claim 1, wherein the styrenic thermoplastic elastomer resin is constituted from styrene, ethylene and butylene, and the molar ratio of styrene/(ethylene+butylene) in the elastomer resin is from 5/95 to 50/50.

5. The rubber-reinforcing carbon fiber cord according to claim 1, wherein the resin composition contains a sticky resin.

6. The rubber-reinforcing carbon fiber cord according to claim 5, wherein the sticky resin contains at least one of a hydrogenated terpene resin, a β-pinene resin and a terpene resin as a component thereof.

7. The rubber-reinforcing carbon fiber cord according to claim 1, wherein the amount of the resin composition adhered is from 1 to 50 parts by weight based on 100 parts by weight of the carbon fiber bundle.

8. The rubber-reinforcing carbon fiber cord according to claim 1, wherein the resin composition has a breaking strength of 0.5 MPa or more and a breaking elongation of 750% or more.

9. The rubber-reinforcing carbon fiber cord according to claim 1, wherein a resorcin-formalin-rubber latex-based resin adhesive adheres to an uppermost surface of thereof.

10. The rubber-reinforcing carbon fiber cord according to claim 1, wherein the number of filaments of the carbon fiber bundle is from 500 to 50,000.

11. A method for producing a rubber-reinforcing carbon fiber cord, characterized in that a carbon fiber bundle is treated with a resin composition containing an acid-modified styrenic thermoplastic elastomer resin.

12. The method for producing a rubber-reinforcing carbon fiber cord according to claim 11, wherein the acid-modified styrenic thermoplastic elastomer resin is a maleic acid-modified styrenic thermoplastic elastomer resin.

13. The method for producing a rubber-reinforcing carbon fiber cord according to claim 11, wherein the styrenic thermoplastic elastomer resin is a styrene-terminated ethylene-butylene copolymer resin.

14. The method for producing a rubber-reinforcing carbon fiber cord according to claim 11, wherein the resin composition contains a sticky resin.

15. The method for producing a rubber-reinforcing carbon fiber cord according to claim 14, wherein the sticky resin contains at least one of a hydrogenated terpene resin, a β-pinene resin and a terpene resin as a component thereof.

16. The method for producing a rubber-reinforcing carbon fiber cord according to claim 11, wherein an uppermost surface thereof is treated with a resorcin-formalin-rubber latex-based adhesive composition.

17. The method for producing a rubber-reinforcing carbon fiber cord according to claim 11, wherein a substantially twistless carbon fiber bundle is treated with a resin composition containing an acid-modified styrenic thermoplastic elastomer resin to prepare a twistless yarn, and a single twist is imparted to the one yarn or a plurality of the yarns combined, in the range shown by the following equation (1):
1.5≦TC≦3.5 Equation (1)
wherein TC=twist coefficient=(1/3,031)×T(D)^{1/2}
T: the number of twists imparted (T/m)
D: the linear density (dtex) of one or a plurality of carbon fiber bundles

18. The method for producing a rubber-reinforcing carbon fiber cord according to claim 11, wherein a substantially twistless carbon fiber bundle is treated with a resin composition containing an acid-modified styrenic thermoplastic elastomer resin to prepare a twistless yarn, a preliminarily twist is imparted to the one yarn or a plurality of the yarns combined, and further, a final twist is imparted thereto in the range shown by the following equation (2):
2.0≦TC(preliminary twist coefficient)≦7 Equation (2)
wherein TC=twist coefficient=(1/3,031)×T(D)^{1/2}
T: the number of twists imparted (T/m)
D: the linear density (dtex) of one or a plurality of carbon fiber bundles

19. The method for producing a rubber-reinforcing carbon fiber cord according to claim 18, wherein the preliminary twist is a twist in the range shown by the following equation (3):
1≦TC≦5 Equation (3)
wherein TC=twist coefficient=(1/3,031)×T(D)^{1/2}
T: the number of twists imparted (twists/m)(T/m)
D: the linear density (dtex) of one or a plurality of carbon fiber bundles

20. A fiber-reinforced rubber material characterized in that the material is reinforced with the rubber-reinforcing carbon fiber cord according to claim 1.
